(19) United States
(12) Patent Application Publication
(10) Pub. No.: US 2015/0120757 A1
(43) Pub. Date: Apr. 30, 2015

(54) Contact Management and Valuation for Inter-Organizational Relationships

(71) Applicant: Cerner Innovation, Inc., Kansas City, KS (US)

(72) Inventors: Brian N. Gillespie, Kansas City, MO (US); Brian L. Hill, Cameron, MO (US); Benjamin D. York, Kansas City, MO (US)

(73) Assignee: Cerner Innovation, Inc., Kansas City, KS (US)

(21) Appl. No.: 14/283,473

(22) Filed: May 21, 2014

Related U.S. Application Data
(60) Provisional application No. 61/897,949, filed on Oct. 31, 2013.

(51) Int. Cl. G06F 17/30

(52) U.S. Cl. CPC G06F 17/30595
USPC 707/748

(57) ABSTRACT

Contacts between organizations with large numbers of individuals associated with the organization can be managed by scoring communications between the individuals within the scope of their work with their organization. The types of communications scored may be emails, cell phone calls, VoIP phone calls, conventional telephone calls, instant messages, social media platforms, and face-to-face meetings. One or more type of communication may be scored higher or lower than other types of communication based upon the value different types of communication bring to the relationship between the organizations. A score for a communication may also be determined based upon the role of individuals involved within their respective organizations, the timing of the communication, the number of recipients of the communication, or any other criteria that impacts the value of the communications to the relationship between the organizations.

### CROSS-REFERENCE TO RELATED APPLICATIONS

The current non-provisional patent application claim priority benefit, with regard to all common subject matter, of an earlier-filed U.S. provisional patent application titled “CONTACT MANAGEMENT AND VALUATION FOR INTER-ORGANIZATIONAL RELATIONSHIPS”, Application Ser. No. 61/897,949, filed Oct. 31, 2013. The earlier-filed application is hereby incorporated by reference into the current application in its entirety.

### BACKGROUND

Managing contacts between large organizations each having multiple individuals is a complicated problem. A single large organization may have dozens, hundreds, or even thousands of individuals associated with it in various roles. When such an organization engages another organization having dozens, hundreds, or even thousands of individuals associated with the second organization in various roles, the corresponding intricate webs of internal relations between the various individuals at the two organizations can be difficult, almost impossible, to identify, track, and value.

### SUMMARY

While organizations such as universities, corporations, charities and the like may exist as distinct legal and conceptual entities, functionally such organizations are made up of the individuals within them. Individuals within an organization may be employees, volunteers, contractors, owners, etc., and may perform a variety of roles within their organization. The value of a relationship between two large organizations often distills down to the relationships between the individuals associated with those organizations, at least at some level.

Often, but not always, the individuals associated with an organization are employees of that organization. An employee's job description with an organization may require them to communicate with individuals associated with another organization. In many instances, the large number of individuals associated with the two organizations interacting with one another as part of their day-to-day employment leads to less than optimal outcomes. For example, multiple individuals with a first organization may be pursuing the same objective, such as servicing a client's needs at a second organization, in a fashion that needlessly duplicates effort, time, and expense, or possibly even in ways that are in conflict. In other instances, too few or even no individuals associated with a first organization may be in contact with individuals at a second organization because each individual incorrectly believes that one of his or her colleagues has taken the initiative in such a communication.

When the organizations involved are complex, with different individuals filling different roles within their organization and having correspondingly different areas of expertise and responsibility, managing the contacts between the organizations can become yet more difficult. For example, if a first organization provides services to a second organization that provides healthcare services, the first organization may desire to productively engage individuals fulfilling different roles at the second organization. In this example, the second organization that provides healthcare services may have individuals associated with it that perform roles such as doctors, nurses, other healthcare providers, executives, administrators, and volunteers. Within each role, individuals may fill even more specific sub-roles, such as an internist, cardiologist, radiologist, pathologist within the larger role of doctor. As used herein, the term “role” may refer to a role, sub-role, or any other characterization that broadly or narrowly describes the function of an individual in association with an organization. A single individual may occupy multiple roles in association with a single organization, and a single individual may be associated with more than one organization in some circumstances.

Appropriate monitoring of the various points of contact between large organizations can enable the improved structuring of one or both of those organizations relative to one another to deliver the products and/or services that are the subject of that relationship with higher quality and/or greater efficiency. For example, individuals at a second organization may affirmatively contact only a limited subset of individuals at a first organization for their service needs, which may indicate that the individuals preferentially contacted have particularly desired skills or experience. In such an example the second organization may comprise an educational institution, a healthcare organization, a business organization, etc. that retains the first organization to provide software services. In the example of software services, the first organization may have designated associates of various types to address software support issues. However, individuals at the second organization may determine that for reasons of knowledge, proficiency, cultural resonance, or other rationales that a subset of the customer service representatives of the first organization are preferred over other customer service representatives within the first organization. In such an example, the first organization may wish to identify the support services individuals preferred by the second organization. By knowing the identity of such individuals, the first organization may reward them for their service, identify the traits they possess that render them particularly valuable to the second organization, identify unique skills possessed by those individuals and tailor training or hiring programs to build or identify those skills, or streamline the first organization's structure to permit the preferred subset of individuals to devote further time to meeting the needs of the second organization.

The complexities of large organizations also prevent the efficient implementation of institutional change, even beneficial change, within those organizations in many instances. By using systems and methods in accordance with the present invention to capture and quantify the value of interactions between individuals in different organizations, communications relating to implementing change can be monitored to ensure that the appropriate individuals in the appropriate organizational roles are engaged in the process. For example, hospitals and other healthcare delivery organizations are highly complicated and specialized entities. Even the most basic of hospitals involves, of course, doctors, nurses, and a large array of other specialized medical service providers. However, even an organizationally simple hospital may also employ administrators, business executives, various legal professionals, individuals responsible for maintenance and/or upgrades of the physical and informational infrastructure, and other employees who are engaged in both the business of running a hospital and in the delivery of medical services to patients. While there are tremendous benefits to implementing technology within a hospital or other healthcare service provider environment, the difficulty of engaging the many types of individuals associated with a hospital or other health care service provider makes the implementation of large scale change difficult, even if the change is highly beneficial and overwhelmingly supported by the individuals associated with the organization. However, by managing the contacts between a hospital or other healthcare service provider organization and a first organization retained by that organization to assist in implementing a beneficial change, the first organization may assure that relevant individuals and levels of individuals are engaged throughout the change process to ensure optimal implementation of the beneficial changes.

One example of a beneficial but sometimes difficult to implement change for a healthcare organization is a transition to digital medical records from paper records. For many years, the promise of digital medical records for streamlining the delivery of health care and improving healthcare outcomes was trumpeted, but the difficulties of moving large healthcare organizations and the many different individuals associated with those healthcare organizations often stood in the way of a rapid transition to a digital medical records system. For difficult but beneficial change such as, but not limited to, a conversion to digital medical records, systems and methods in accordance with the present invention may provide current information that succinctly describes the relationship between the organizations implementing the change.

The present invention enables the monitoring and evaluation of contacts between large organizations, which may be particularly advantageous in implementing difficult and beneficial change within one or both organizations. Such change may be the subject of a commercial transaction, such as the sale of software and/or software services from a first organization to a second organization, but need not be of a commercial nature. The nature of the relationship between organizations, such as whether or not that relationship is of a commercial nature, may vary without departing from the scope of the present invention. While many examples described herein relate to the sale, implementation, and servicing of software implementations, particularly within a healthcare environment, other types of commercial relationships between large organizations may benefit from systems and methods in accordance with the present invention.

In accordance with the present invention, contacts between individuals at a first organization and at a second organization may be scored. The type of communication(s) scored may be electronic mail (email), instant messaging (IM), telephone calls, voice over Internet protocol (VoIP) calls, mobile telephone calls, face-to-face meetings, social media communications, and/or any other type of interaction. For example, some communication types may be synchronous, such as telephone calls, mobile telephone calls, VoIP calls, and face-to-face meetings, while other types of communications may be asynchronous, like email, instant messaging, and social media interactions. Different types of communications may be more important for different types of relationships. For example, a synchronous communication with a technology support individual may often be of higher importance than an asynchronous communication with a technology support individual, as a synchronous communication in such an example may indicate an urgent need due to a possible technological shortcoming while an asynchronous communication may indicate something other than an urgent need. Similarly, the identities of individuals involved in a communication, the roles of individuals involved in a communication, the timing of a communication, and other factors may impact the importance of that communication to the relationship between the organizations. Accordingly, in many circumstances different types of communications may be valued differently. Communications may be scored based upon a description of the communication that may be retained on a communication server, stored in a database automatically (such retaining may occur substantially simultaneously with the communications themselves or periodically by accessing a relevant communication server), and/or by manually entered as the communications occur or after the communications occur. A description of a communication may be retained as one or more field in one or more database to provide information such as, for example, the individual(s) sending a communication, the individuals(s) receiving a communication, the type of communication (such as email, IM, VoIP call, mobile phone call, social media contact, etc.), the time and date of the communication, etc. The present invention is not limited to any particular type of description of a communication(s), and systems and methods in accordance with the present invention may utilize descriptions of communications that differ in describing a communication(s) by providing more, less or different types of information.

For various implementations of the present invention, the value assigned to a particular communication by a calculated score may vary based upon assorted parameters associated with that communication. For example, some types of communications may be determined to be more valuable than other types of communications within the context of the relationship between organizations. For example, face-to-face meetings may be more valuable than emails, while emails may be more valuable than IM's. Communications may be classified according to various types or sub-types of communication. For example, one type of communications may be synchronous (such as face-to-face meetings, telephone calls of various types, and video conferences) while another type of communications may be asynchronous (emails and social media interactions, for example). In such an example, the weighting accorded to a particular communication may depend only upon its type (synchronous or asynchronous) or may additionally or alternatively depend upon the sub-type (face-to-face meeting vs. telephone call). Rather than keeping a simple count of the total of communications, systems and methods in accordance with the present invention may mathematically weight some types or sub-types of communications as being more valuable for organizational relationship purposes than others, although this is not necessary in accordance with the present invention, and all communications considered may be weighted equally without departing from the scope of the present invention.

Further, communications between individuals may be valued differently based upon the number of individuals involved in the communication. For example, an email exchange between a first individual at a first organization and a second individual at a second organization may provide greater relationship value then a single email sent by a first individual at a first organization to a large recipient list of dozens or more individuals at a second organization. Accordingly, the value associated with a communication by a calculated score may be adjusted based upon the total number of recipients (or other participants) of that communication. For example, the score assigned to a communication may be inversely proportional to the number of recipients of that communication. Further, the value of a communication with multiple recipients, for example multiple individuals associated with a second organization, may be discounted by each individual recipient while being quite valuable in the aggregate to the second organization as a whole and to the first organization tasked with developing that relationship. Accordingly, scoring functionality may value an email or other communication directed to multiple recipients differently for relationship scores built between individuals at different organizations and scores built to show the strength contributed to the relationship between the organizations overall. The scoring of multi-participant communications may be different for different types or sub-types of communications. For example, an email may be scored to be inversely proportional to the number of participants, while a face-to-face meeting may receive a different, or even no, adjustment based upon the number of participants.

The value of a communication upon the relationship between a first organization and a second organization may also depend upon the identities of the individuals involved in the communication and the roles they play within the organization. For example, the CEO of a healthcare organization may be particularly critical in the formation of a relationship between the healthcare organization and a first organization that is engaging with the healthcare organization to implement change such as a transition to digital medical records. Accordingly, communications between an individual at first organization and the CEO of the healthcare organization may receive extra weight in a scoring algorithm to reflect the importance of that individual relationship. Of course, relationships with individuals other than a CEO or similar executive may be of particular importance to a successful implementation of desired change to which the first organization is tasked. For example, in addition to valuing communication with the CEO of a healthcare organization, the first organization may also choose to highly value communications with his or her personal assistant, various leaders amongst the doctor and nurse ranks, etc. Further, by identifying different categories of individuals at a second organization based upon the roles filled by those individuals, the first organization may independently score and evaluate the quantity and quality of its engagement with different subsections of the second organization. For example, a first organization that is engaging with a healthcare organization may identify categories of individuals that must be engaged with and then score the contacts between individuals at the organizations to ensure that, for example, executives, doctors, nurses, and administrators are actively engaged in an effective way by individuals associated with the first organization.

The timing of a relationship between organizations may also impact the value of a communication. Further, the timing of the relationship may impact the nature and role of individual at a second organization with whom communication is most valuable. Accordingly, the scoring of a communication may be increased or decreased based upon the timing of the relationship between the organizations, either alone or in conjunction with the identity and/or role of the participants in that communication. For example, as the installation and implementation of a complicated software solution progresses the individuals who are critical for engagement may vary. In the example of implementing a digital medical records system, initially the various executives and administrators may need to be engaged to approve and plan the implementation. However, once given authorization and presented with a budget, the first organization in such an example may need to swiftly and continuously engage the doctors within such a healthcare organization both to explain the benefits of the transition and to obtain ongoing feedback from the doctors regarding the critical details of their medical practice to structure the implementation in a fashion that does not disrupt their work but rather enhances and simplifies their medical practice. Further, engagement with medical support staff, such as nurses, may be critical as the implementation progresses to ensure that systems put in place are well-suited and adapted to the unique workflows at the second organization and to ensure that any required support, education, and training has been provided. Ultimately in such an example, periodic engagement with administrative personnel at the healthcare organization may be required for purposes such as ongoing maintenance, updating, and regulatory compliance for such a service. Some of the individuals at such a healthcare organization, such as the doctors, may be vital to the ongoing relationship, and therefore contacts with them may be valued highly during the duration of the relationship. However, communication with some individuals may be of extreme importance at particular times of the process but of lesser importance at other times in the process and, therefore, communications with those individuals and the first organization may be scored more highly during critical times and less highly at non-critical times.

While the value of systems and methods in accordance with the present invention may be particularly captured by including in the scoring a large volume of communications approaching, as near as possible, the totality of communications between individuals at the two organizations, certain communications optionally may be excluded from consideration and scoring without departing from the scope of the present invention. For example, a sub-score focusing on only a particular aspect of the relationship, such as the technological support provided by the first organization to the second organization, may be desired and, accordingly, only communications with individuals associated with an organization in a particularly relevant role or roles may be considered in scoring and evaluation of communications. Further, some types of communications or communications between certain individuals optionally may be excluded from scoring in accordance with the present invention due to ethical or legal concerns, but also may be excluded because they can misrepresent the nature and quality of the relationship between the organizations. For example, individuals at the first organization may have friends or relatives within the second organization, and these individuals may use communication technology from their workplaces to communicate with one another regarding matters outside of the scope of the relationship between the first organization and the second organization. Such communications may be excluded from consideration and scoring in accordance with the present invention. Communications between individuals relating to personnel matters, legal concerns, or other issues may be determined to be outside of the scope of the relationship for which quantification and scoring is desired and, therefore, may be excluded from the determination. A communication may be excluded based upon one or more party to the communication or the role of that individual within an organization, the communication type or account, the time of the communication, etc. Further, optionally only a portion of a communication may be analyzed in accordance with the present invention. For example, only certain fields of a communication such as an email may be considered, such as the to, from, and cc fields, while other fields such as a subject line or the email message text itself may not be considered or even retrieved from a communication server. On the other hand, all or most of the fields of a message may be analyzed to score a communication contact in accordance with the present invention.

Broadly speaking, systems and methods in accordance with the present invention may systematically identify and score communications between individuals at a first organization and individuals at a second organization. Communications identified and scored in accordance with the present invention may be unidirectional (such as from the first organization to the second organization) or bidirectional (both from the first organization and from the second organization). If multiple organizations are involved in the relationship or interest, the communications may be tri-directional, etc. Further, communications may be synchronous (with all participants engaging essentially simultaneously) or asynchronous (with some or all participants engaging non-simultaneously). Communications may be scored directly based upon an analysis of the communication itself or indirectly based upon an analysis of a record or other description of the communication.

Each individual communication may be scored in a fashion that is dependent upon the identity of the individuals engaged in the communication, the role of individuals engaged in the communication, the communication type, the timing of the communication relative to a larger process that relates to the relationship between the organizations, and/or the number of individuals involved in that communication. In such a scoring, each individual communication contact considered may receive a numeric value. The numeric value for all or some of the individual communication contacts between individuals in the first organization and individuals in the second organization may be summed to provide an indication of the quality and quantity of engagement between the first organization and the second organization and various individuals associated with the first organization and the second organization. Further, separate sums of contact scores may be provided for contacts with the organizations as a whole, between a single individual at the first organization and the entirety of the second organization, with a given individual at the second organization, with individuals in a particular role(s) at the second organization, within a given timeframe of interest, etc.

Further, contacts may be scored in a unidirectional or a bidirectional fashion. For example, a contact from a first individual at the first organization may receive the same value as a communication from a second individual at the second organization to the first individual at the first organization. On the other hand, certain circumstances may indicate that communications may be appropriately valued more or less when they proceed in a particular direction. For example, communications from the second organization, or even particular individuals at the second organization, that are directed to individuals at the first organization may receive additional valuation and weight in scoring. For example, the individuals contacted at the first organization by individuals at the second organization responsible for critical decision-making may be deemed particularly valuable and may be advantageous in identifying the most critical individuals at the first organization to the relationship with the second organization.

### BRIEF DESCRIPTION OF THE SEVERAL VIEWS OF THE DRAWINGS

The present invention is described in detail below with reference to the attached drawing figures, wherein:

FIG. 1 is a schematic diagram of an exemplary system for scoring contacts between individuals at different organizations;

FIGS. 2a-2d illustrate exemplary contacts between individuals at two different organizations and the scoring of those contacts;

FIGS. 3a-3b illustrate additional exemplary contacts between individuals at two different organizations and the scoring of those contacts;

FIG. 4 illustrates an exemplary method for managing and scoring contacts between individuals associated with different organizations; and

FIG. 5 illustrates a further exemplary method for managing and scoring contacts between individuals associated with different organizations.

### DETAILED DESCRIPTION

Various examples of systems and methods in accordance with the present invention are described herein with regard to the attached drawings. The drawings and the associated descriptions are exemplary only. Systems and methods practicing the present invention may depart from the examples shown and described herein.

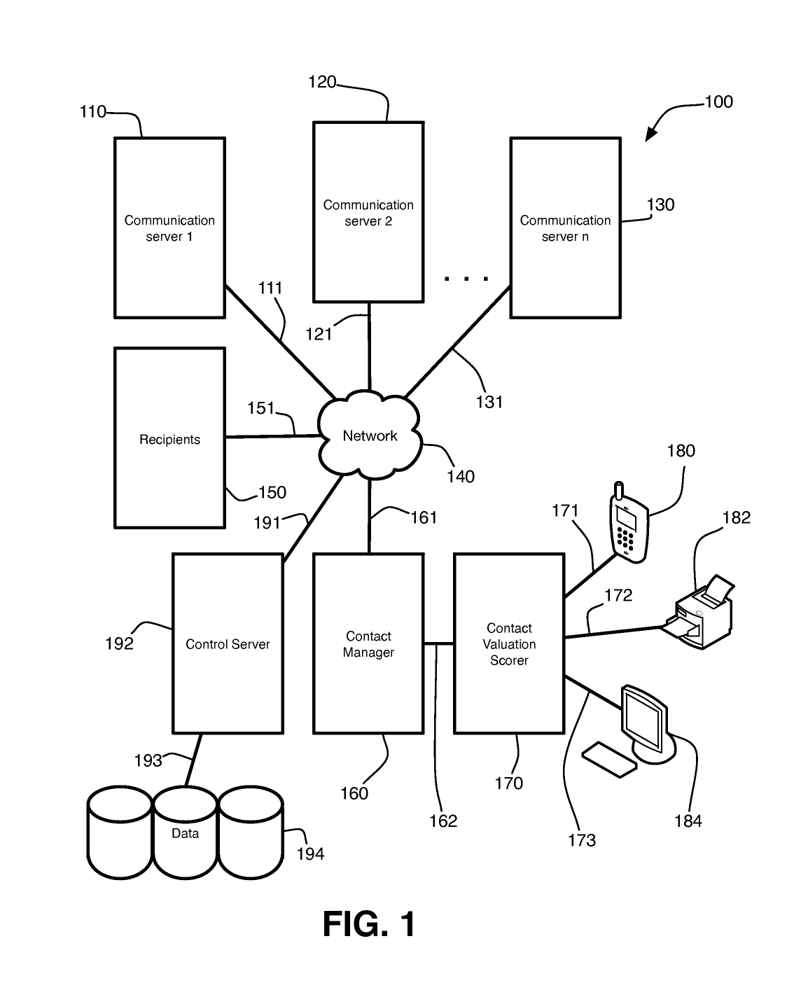

FIG. 1 schematically illustrates one example of a system 100 in accordance with the present invention. One or more communication servers, such as a first communication server 110, a second communication server 120, up to an nth communication server 130 may be used to facilitate communications between organizations and/or to document or otherwise record pertinent descriptive details of communications between individuals in different organizations. Examples of various types of communication media that may use the communication servers are email, mobile telephone calls, VoIP calls, instant messaging, social media, conventional telephone communications, calendaring functions to maintain schedules for face-to-face or other types of meetings, or any other type of communication. Various communication servers may access a network 140 via connections 111, 121, 131 to send or receive communications with the appropriate individual or individuals. Recipients of communications from the various communication servers 110, 120, 130 may receive and respond using one or more communication servers, such as those illustrated or other servers.

Communications may extend through a single or multiple networks. The networks may exchange communications that are packet-based, circuit-based, or in any other format. Face-to-face meetings may be represented digitally as calendar entries or in other fashions. The precise nature of the network(s), server(s) or other computer(s) employed, and/or other communication equipment may be varied without departing from the scope of the present invention. Records that describe communications may be stored on the communication servers 110, 120, 130 themselves, and/or records providing a description of the communications may be retained in a database retained on a database cluster 194 under the control of a control server 192. Control server 192 (as well as any or all of communication servers 110, 120, 130, contact manager 160, and contact valuation scorer 170) may comprise a general purpose computing device and may include components such as, but not limited to, a processing unit, internal system memory, and a suitable system bus for coupling various system components, including database cluster 194, to the control server 192. The system bus may be any of several types of bus structures, such as a memory bus or memory controller, a peripheral bus, and a local bus using any of a variety of bus architectures. By way of example, but not limitation, such bus architectures may include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus. Control server 192, as well as communication servers 110, 120, 130, contact manager 160, and/or contact valuation scorer 170 and any additional computing device(s) in system 100 may include or have access to a variety of computer readable media, such as database cluster 194 or a similar database cluster. Computer readable media may be any available media that can be accessed by a computing device, and includes both volatile and nonvolatile media and both removable and nonremovable media. By way of example, and not limitation, computer readable media may comprise computer storage media and communication media. Computer storage media includes both volatile and nonvolatile and removable and nonremovable media implemented in any method or technology for information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by a computing device (such as control server 192, any of communication servers 110, 120, 130, contact manager 160, and/or contact valuation server 170). Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as wired network or direct-wired connection, and wireless media such as acoustic, RF (e.g., Bluetooth), infrared, optical and other wireless media. Combinations of any of the above should also be included within the scope of computer readable media. Computer storage media used in system 100, for example in database cluster 194, may provide storage for computer readable instructions, data structures, program modules, and other data for computing devices such as control server 192, communication servers 110, 120, 130, contact manager 160, and contact valuation server 170.

A contact manager 160 may comprise software operating on a computing device to access relevant information on one or more communication server 110, 120, 130 or on database cluster 194, either directly or over a network 140 via connection 161, to identify and appropriately score various communication contacts and/or descriptions of communication contacts recorded on the communication servers 110, 120, 130 and/or database cluster 194. The scoring of individual communication contacts may be performed by a contact valuation scorer 170 connected 162 to contact manager 160. Contact valuation scorer 170 may comprise software operating on a computing device either as a component of contact manager 160 or as a discrete entity. Scoring of communication contacts may proceed in a variety of fashions, some examples of which are described herein. More particularly, contact valuation scorer 170 may estimate a value of each individual communication that increments a counter based upon each additional communication identified by a value associated with that communication. Alternatively/additionally, contact valuation scorer 170 may determine the score of different communication contacts based upon the nature of the communication, the individuals participating in that communication, the time of that communication, etc. The contact manager 160 and/or the contact valuation scorer 170 may output information relating to scoring and valuation of communication contacts in a variety of fashions. For example, a score may be the output on a display device associated with a computer 184, such as via a web application or an intranet website. Similarly, scores may be output on a mobile device 180 or, if desired, printer 182 or output to other types of media, such as a digital storage device.

Various computing devices in a system in accordance with the present invention, such as the example system 100 illustrated in FIG. 1, may operate over one or more networks such as network 140 using logical connections to the various computing devices (such as communication servers 110, 120, 130, contact manager 160, contact valuation scorer 170, and control server 192) and/or to one or more remote computers. Remote computers may be located at the premises of a first organization or a second organization or elsewhere. Such remote computer(s) may be personal computer(s), hand held computer(s) such as PDAs, laptop device(s), cellular phone(s), kiosk(s), server(s), router(s), network PC(s), peer device(s) or other common network node(s), and may include some or all of the elements described above with regard to control server 192, communication servers 110, 120, 130, contact manager 160, and/or contact valuation scorer 170. Network 140 may comprise any type of network, such as local area network (LAN), a wide area network (WAN), or any other type of network. Network 140 may comprise an enterprise-wide network, and intranet, and/or the Internet. System 100 and the computing devices of system 100 may include modems or other communication interface technology for establishing communications the appropriate network(s), such as network 140. Various program modules or portions of program modules executed in systems and methods in accordance with the present invention may be stored at various locations, and may be stored at a single location or multiple locations. For example, and not limitation, various application programs may reside in memory associated with contact manager 160, contact valuation scorer 170, control server 192, database cluster 194, one or more of communication servers 110, 120, 130, etc.

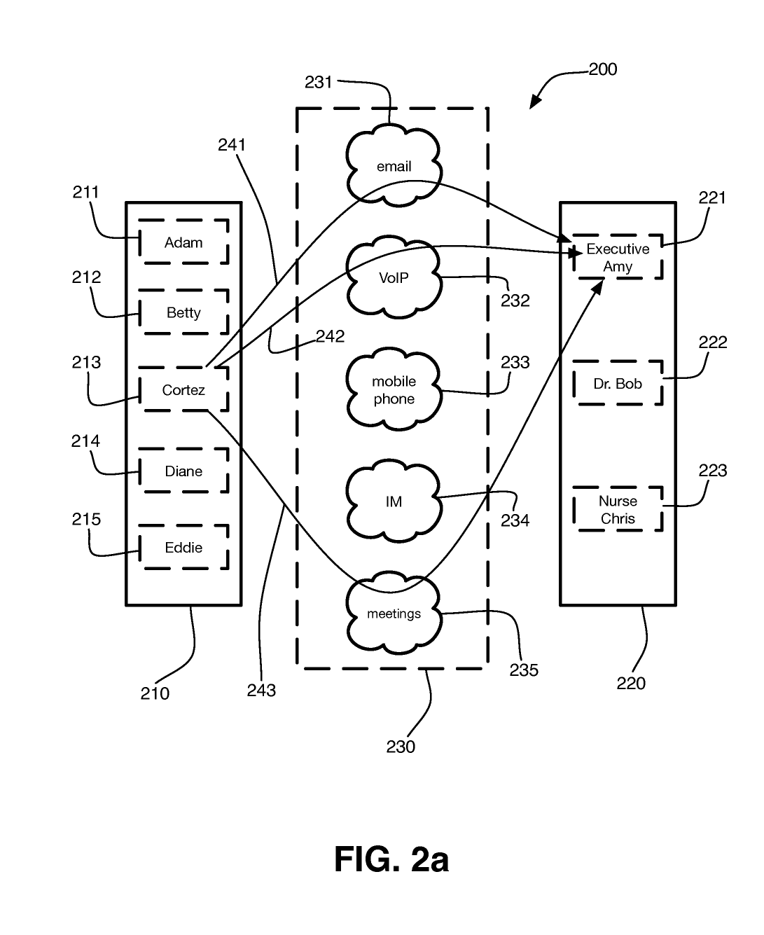

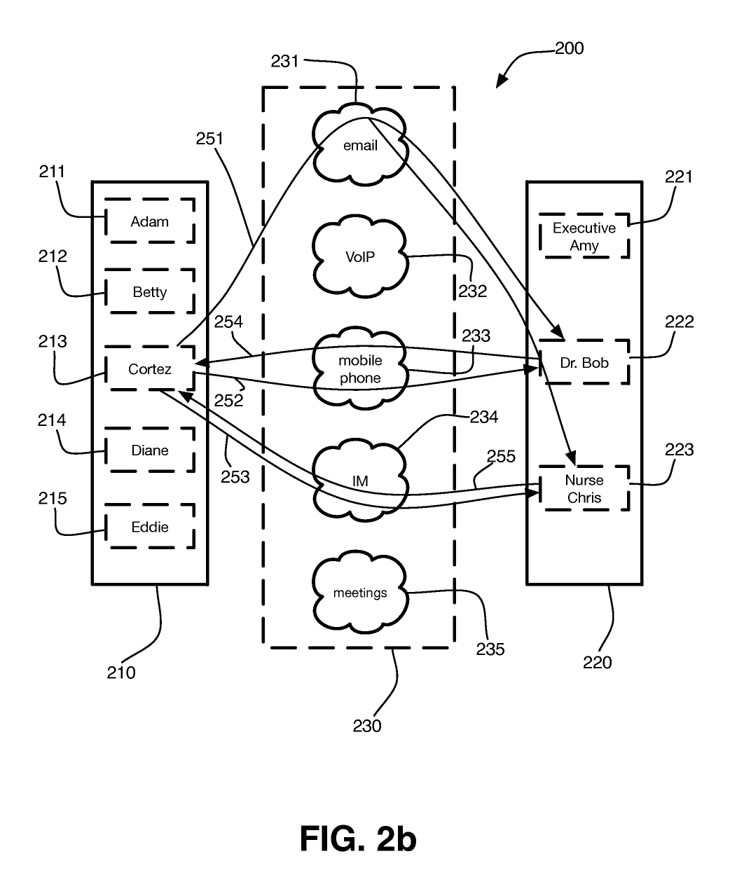

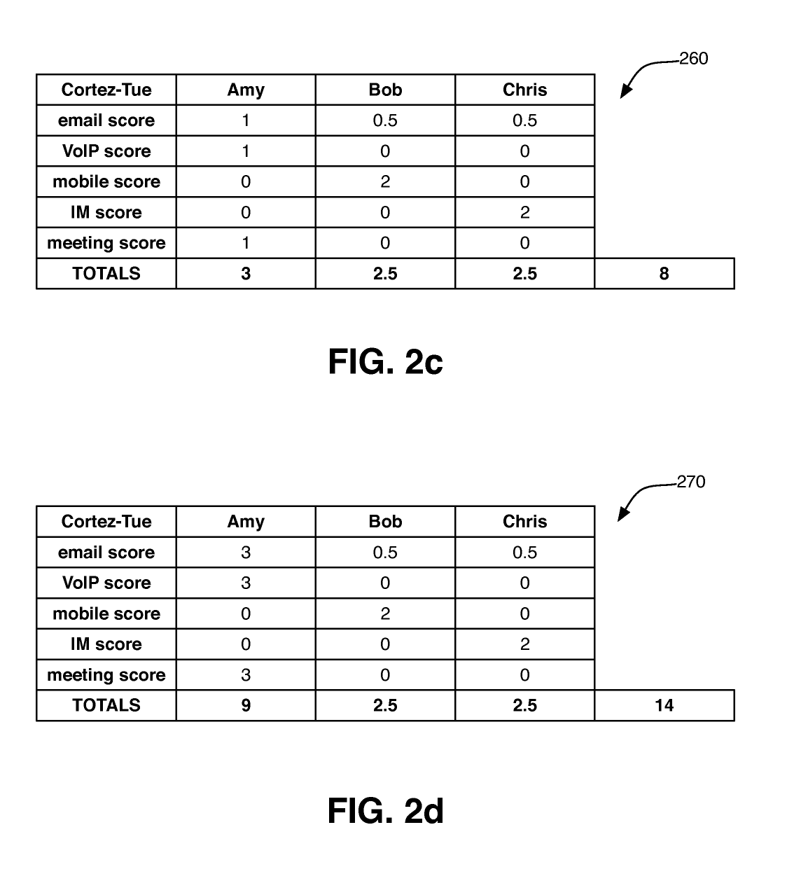

FIG. 2a depicts a simplified communication arrangement between individuals at a first organization 210 and individuals at a second organization 220. In the simplified example of FIG. 2a, individuals at the first organization 210 are Adam 211, Betty 212, Cortez 213, Diane 214, and Eddie 215. Each of the individuals with the first organization 210 may have similar duties and roles within the first organization 210, but may also possess different roles and responsibilities. Individuals associated with the second organization 220 are identified in conjunction with their roles at the second organization 220. For example, Amy 221 may be an executive, such as a CEO, at the second organization 220, which may be a healthcare service provider. Also within the second organization 220, Bob 222 may be a doctor engaged in providing healthcare services on behalf of second organization 220. By way of further example, Chris 223 may be an individual employed as a nurse in the provision of healthcare services by the second organization 220.

A variety of communication methods and media 230 may be used in contacts between individuals at the first organization 210 and individuals at the second organization 220. For example, individuals may exchange emails 231, may engage in VoIP calls 232, may engage in mobile phone calls 233, may engage in instant messaging (IM) 234, and may engage in face-to-face meetings 235. Of course, other types of communication, such as over social media, may be utilized and scored in accordance with the present invention as well.

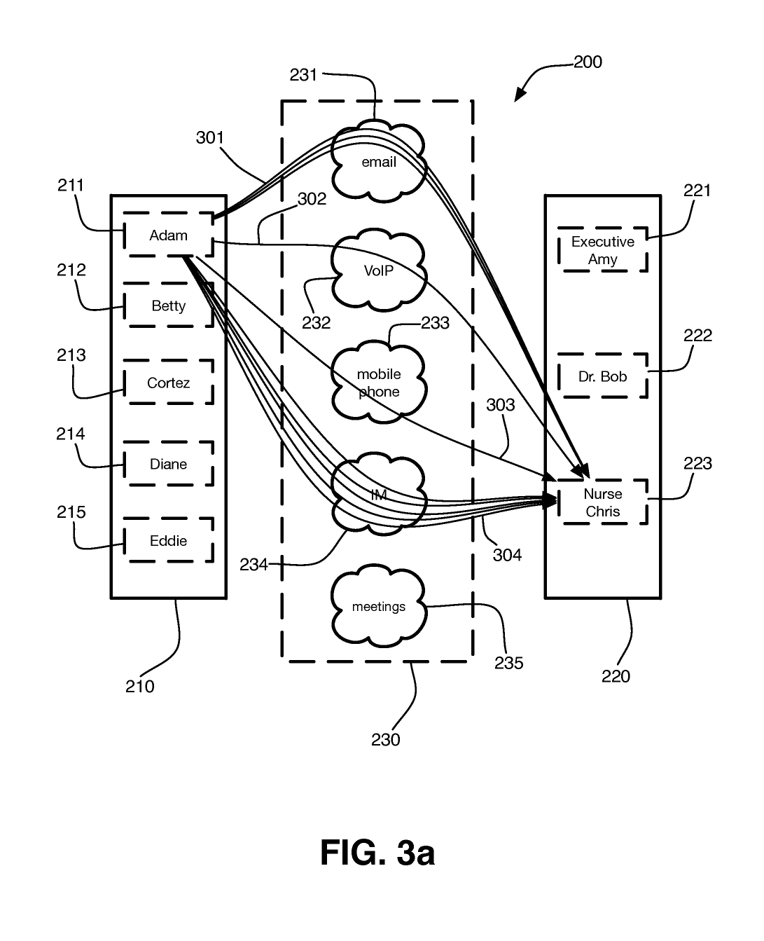

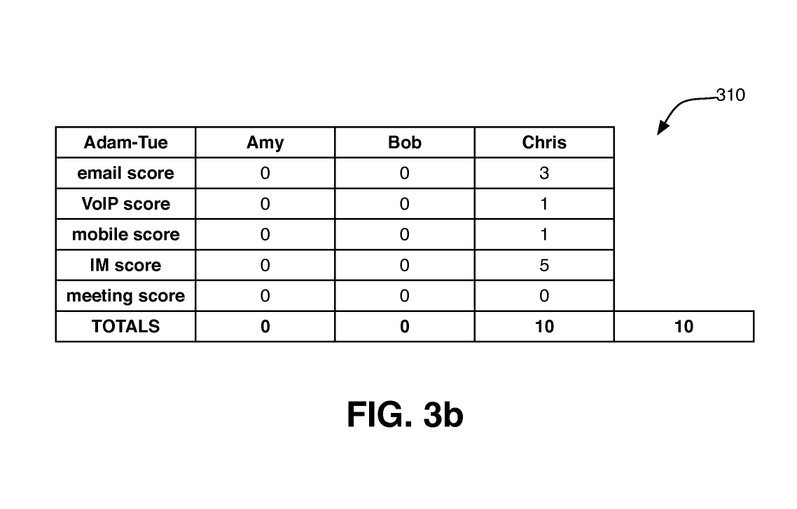

As shown in the simplified examples of FIGS. 2a, 2b and 3a, different individuals may communicate with one another in different ways and with different frequencies. For example, as shown in FIG. 3a Adam 211 may exchange multiple email 231 messages 301 with Nurse Chris 223 but not contact Executive Amy 221 at all. As shown in the example of FIGS. 2a and 2b, Cortez 213 may contact Executive Amy 221 via an email 231 message 241, via a VoIP 242 call 242, and a single 243 meeting 235. As also shown in the example of FIG. 2b, Dr. Bob 222 may contact Cortez 213 via a mobile phone 233 contact 254, and Nurse Chris 223 may contact 255 Cortez 213 via instant message 234. In practice, actual communications between individuals associated with a first organization 210 and individuals associated with a second organization 220 may involve many more contacts than depicted in the simplified examples of FIGS. 2a, 2b, and 3a. In accordance with the present invention, different types of contacts may be valued differently, and may accordingly have scores assigned to them that accurately reflect the importance of those contacts to the organizations.

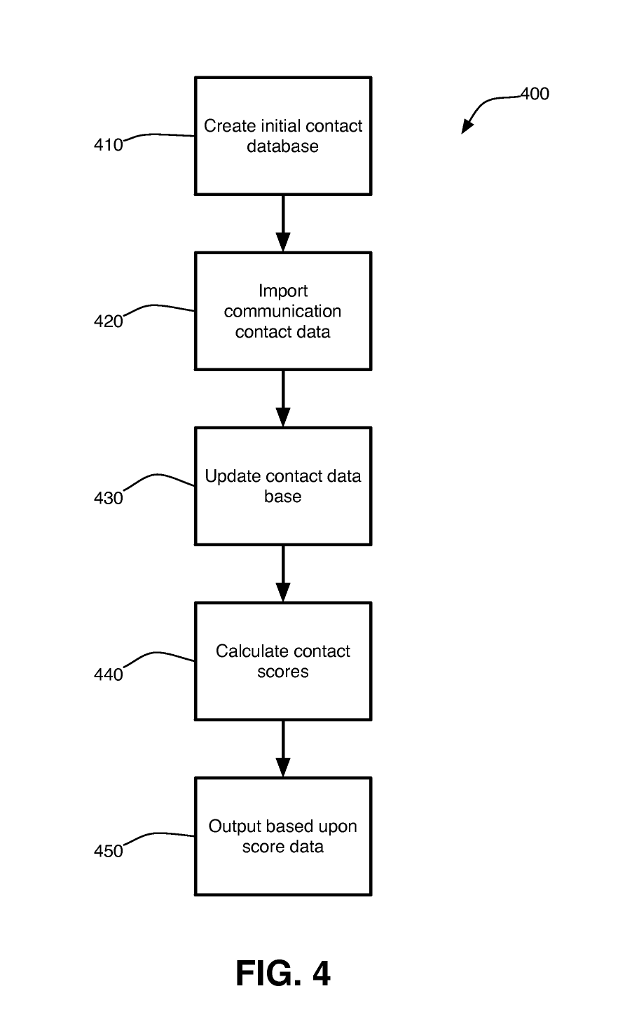

FIG. 4 illustrates an example of a method 400 in accordance with the present invention. The method 400 may optionally begin with the creation 410 of an initial contact database. For example, the identities of individuals and their roles and responsibilities may be initially entered into a database. By way of example, but not of limitation, step 410 may create a database in the example system 100 of FIG. 1 using data cluster 194 to store records.

Communication contact data may be imported 420, for example into or under the control of a contact manager, such as contact manager 160 illustrated in the example of FIG. 1. Importing communication contact data 420 need not, and in many instances perhaps should not, involve importing the entirety of a communication itself; however, importation step 420 may import the entirety of some or all communications in some circumstances. In many circumstances, only a description of the communications may be imported in step 420. A description of a communication may identify the type (or sub-type, if defined or desired) of communication, the individuals engaged in that communication, the individual(s) initiating the communication, and the time/date of the communication, or any other parameters that provide a useful description of the communication for subsequent analyses. The identities of individuals involved in a communication may be determined using email addresses, telephone numbers, and other types of usernames or identifiers. Information such as a role associated with individuals involved in a communication may be determined from the identity of those individuals after importation 420, although in some examples a role may be provided in the communication itself so as to permit importation 420 of the role of individuals participating in a communication.

Based upon imported communication contact data, an initially created database may be updated 430. For example, imported communication contact data may identify individuals not previously included within the contact database. In this fashion, the contact database may be maintained as a reasonably complete representation of the individuals at the organizations involved.

Contact scores may be calculated 440 based upon the imported communication contact data. Step 440 of calculating scores may be performed, for example, by a contact valuation scorer 170 in the exemplary system 100 illustrated in FIG. 1. The calculation of contact scores 440 may involve assigning a score to some or all of the individual communications that were exchanged and summing those scores over communications considered for scoring. For example, the scores of individual communications may be calculated and summed for an entire organization, for only individuals having particular role(s) with an organization, only for specific periods of time, for particular individual(s), or for individuals in particular roles with an organization. Scoring 440 may assign different values to different communications. In one example, communications may be weighted differently based upon the type of communication involved, with, for example, an email being valued at a different amount than a VoIP call. By way of further example, communications may be valued differently based upon the number of recipients of the communication. For example, an email may be valued proportionally to the number of recipients to the email. Optionally, some types of emails, such as to generic mailing lists, may be valued less or not at all. As an additional example, communications with individuals having a particular role with an organization may be valued differently, either more or less, than communications with individuals in other roles. Further descriptions of examples of scoring calculations are described in greater detail herein, but the precise score calculation methodology may vary based upon the nature of the organizations involved and the nature of the relationship between the organizations.

Ultimately an output 450 may be generated based upon a calculated score. In some examples, an output may be a representation of the calculated score, either in a predetermined fashion or in a dynamic fashion as requested by a user. For example, outputting 450 may comprise preparing at regular intervals reports showing the scores associated with particular individuals employed at an organization. By way of further example, a search may be used to produce an output identifying the individuals at a first organization who have been in contact with a specific individual or group of individuals at a second organization, which may be valuable in focusing future implementation efforts, etc.

A further example of an output 450 based upon a calculated score could be an alert, notification, or alarm issued if a score falls above or below a threshold or above or below a desired range. For example, a score calculated based upon individuals associated with a technical support role may exceed a threshold determined to be acceptable. In such an example, an alert could be issued based upon that score indicating that technical support needs have increased, thereby permitting additional technical support individuals to be engaged and/or to permit troubleshooting of a product or service to identify the potential cause of the increased technical support demand. By way of a further example, a score calculated for a first organizations sales team may indicate that the sales team is failing to adequately engage individuals within a particular role at a second organization, resulting in a notification permitting the sales team to be directed to engage with the appropriate individuals at the second organizations.

The outputting 450 based upon score data may occur in a physical printed fashion, in an electronic fashion, may be displayed on a screen or other display device, or in any other manner. Different types of outputs may take different forms and be directed to different recipients. For example, an output generated to provide a depiction of the score data may be created only when requested by a user and in a fashion determined by the requesting user, while an alert, alarm, or notification may take the form of an email, phone call, instant message, or other automated output format directed to an individual or individuals responsible within the organization for addressing or monitoring the portion of the relationship subject to the score data.

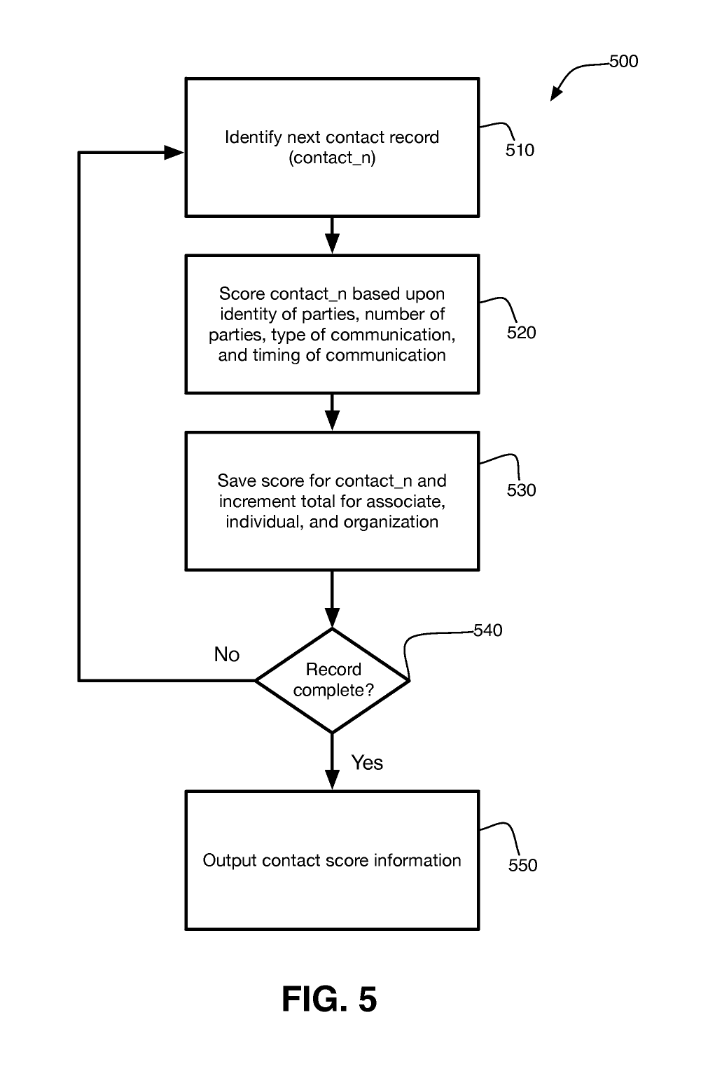

Referring now to FIG. 5, a further example of a score calculation method 500 is depicted. The method 500 depicted in FIG. 5 may begin by identifying a contact record 510, for example in a communication server or elsewhere. The step of identifying a contact record 510 may occur simultaneously or sequentially for different types of communication and across multiple communication servers. The contact record may be the communication itself or a copy of the communication itself, but may also be a description of the communication.

The identified contact record may be scored 520 based upon a variety of criteria. Generally speaking, these criteria may involve the identity and/or roles of the parties engaged in the communication, the number of parties engaged in the communication, the type (or sub-type) of communication, and/or the timing of communication. Further examples of calculation methodologies and algorithms are discussed in further detail below.

The score for an individual contact record may be saved 530. Further, a total score may be incremented to add an individual calculated score. Score totals may be incremented that are associated with a specific individual, a specific portion of an organization, a specific category of individuals, or organization as a whole, for example.

After saving and/or scoring based upon the score calculated from a single communication record, a determination 540 may be made as to whether the accessing and scoring of contact records, for example on the same or a different communication server or elsewhere, is complete. If the conclusion is that contact records remain to be accessed and scored, the method 500 may return to identify 510 the next contact record at the same or a different communication server. If the analysis of contact records is complete, the method 500 may proceed to generate 550 any desired output contact score information.

A simplified example of tables that may be generated for particular individuals charged with facilitating communication with a second organization from the example depicted in FIGS. 2c, 2d, and 3b are shown. In these examples, a hypothetical single day of contacts is illustrated with various simple examples of scoring methodologies shown. However, systems and methods in accordance with the present invention may be implemented over timeframes both less and more than a single day. Further, more sophisticated scoring algorithms than those illustrated in the examples of the present tables may be utilized as well. Some further sophisticated examples of scoring algorithms in accordance with the present invention are described herein, but the present invention is not limited to any particular scoring algorithm.

In the first example shown in FIG. 2c, the contacts made by Cortez to individuals at the second organization and contacts from individuals at the second organization to Cortez are depicted. Different types of communication available for communications with Cortez are emails, VoIP calls, cell phone calls, instant messaging, and face-to-face meetings. Each of the three example individuals within the second organization illustrated in FIGS. 2a and 2b was contacted in some way by Cortez in the time shown for the present example of FIG. 2c, and Cortez was contacted by Dr. Bob by mobile phone and by Nurse Chris via IM.

In the example of FIG. 2c, Cortez had a score of 1 for email communications with Amy, a score of 1 for VoIP calls with Amy, a score of 0 for mobile phone and instant messaging communications with Amy, and a score of 1 for face-to-face meetings with Amy. The total score for Cortez in communications with Amy in this example is 3. Meanwhile, in communications with Bob, Cortez obtained a score of 0.5 for emails, a score of 0 for VoIP calls, a score of 2 for mobile phone calls (for one call to Doctor Bob and one call from Doctor Bob), and a score of 0 for instant messages and face-to-face meetings. The 0.5 score for emails between Cortez and Bob is due to the scoring algorithm utilized in this example, which assigns a value of one to each email but divides that value by the total number of recipients. Accordingly, Cortez may have sent one email to both Bob and Chris, resulting in an email score of 0.5 with regard to both Bob and Chris. With regard to Chris, Cortez also received a score of 2 for IMs, from one IM sent by Cortez to Chris and one IM sent from Chris to Cortez.

Still referring to the present example of FIG. 2c, Cortez achieved a total score of 2.5 with Bob and a score of 2.5 with Chris. In this example, a total organization contact score quantifying the contacts between Cortez and the second organization has been determined by simply totaling the individual contact scores, resulting in a total organization contact score of 8 for Cortez.

In a second example shown in FIG. 2d, the same communications between Cortez and individuals at the second organization illustrate in FIGS. 2a and 2b may be scored and weighted differently than shown in the example of FIG. 2c. In the example depicted in FIG. 2d, communications with Amy are valued more highly than other communications. This valuation is indicated by the weighted score entry, which reflects a tripling of scores associated with Amy but no increase in scores for communications associated with Bob and Chris. As a result of the weighting, Cortez receives a score of 3 for a single email with Amy, a score of 3 for a single VoIP call with Amy, and a score of 3 for a single meeting with Amy, while receiving scores for communication contacts with Bob and Chris with the same scores as described with regard to FIG. 2c, resulting in a total score in the example of FIG. 2d of 14 for Cortez. This example serves to illustrate that different communications can be valued differently in a score based upon the identity of individuals involved in that communication. Other weightings are possible using algorithms and systems and methods in accordance with the present invention.

A further example of scoring communications is shown with regard to the individuals illustrated in a first organization and a second organization in FIG. 3b. FIG. 3b illustrates an example of scoring the communications depicted in the example of FIG. 3a. In the example shown in FIG. 3b, Adam has had no communications with Amy and Bob, leading to total scores with those two individuals of 0. However, in the example shown in FIG. 3b, Adam has communicated frequently with Chris, achieving an email score of 3 for 3 sent emails, a VoIP call score of 1 for 1 VoIP call, a mobile phone call score of 1 for 1 mobile phone call, and an instant messaging score of 5 for 5 instant messages. The total score for Adam with regard to Chris is 10. Because Adam engaged in no communications with individuals at the second organization other than Chris, the total organization score achieved by Adam in this example is 10.

The score for the same total number and types of communications engaged in by Adam in the exemplary differently weighted system illustrated with regard to Cortez in FIG. 2d would be unchanged from the scores shown in FIG. 3b, because Adam did not engage in communications with Amy or any other individual for whom extra weighting is added.

While the above examples illustrate a scoring algorithm that merely weights contacts based upon the individual engaged in the communication at the second organization and the number of recipients of the communication, other types of scoring algorithms may be employed for scoring in accordance with the present invention. For example, face-to-face meetings may be particularly valued and, therefore, made be scored more highly by applying a multiplication factor corresponding to the additional value provided. By way of further examples, synchronous communications may be valued more highly than asynchronous communications, or recent communications (occurring within a specified period of time, for instance) may be valued more highly than less recent communications. Such valuation factors may be greater than one but, alternatively, may be less than one for communication methodologies that are less valuable. Any number of valuations may be implemented simultaneously, for example by highly valuing recent synchronous communications with individuals having particular roles.

As noted, scores for particular types or instances of communication may be weighted more or less based upon the timing of that communication. During a critical implementation phase of a software project, for example, communications with individuals associated with the implementation and testing of that project may receive extra weight by multiplying a score by an appropriate factor, while at other times those communications may receive no additional weight or even lesser weight by multiplying by a factor of less than one. The particular ways in which communications are weighted by factors that increase or decrease the value assigned to those communications may be premised upon the organizations involved in the relationship and the nature of that relationship. As noted in some examples above, communications may be valued in a fashion that recognizes the number of individuals participating in that conversation. Such an approach may be justified in some, but not all, circumstances and may accordingly be used or disregarded without departing from the scope of the present invention. For example, an email sent to a single individual may provide greater communication value between organizations than an email sent to twenty individuals. One way of decreasing the weight of an individual email in scoring is to divide the value associated with that email, which may be one, by the number of recipients. However, the value of a communication such as an email may decrease more rapidly as more recipients are added, may decrease less rapidly as more recipients are added, or may decrease not at all as recipients are added. Therefore, the particular factor by which valuation is decreased need not be inversely proportional to the number of recipients.

Further, certain types of communications may be excluded from consideration by systems and methods in accordance with the present invention entirely. The reasons for such exclusion may vary, but may include exclusion for ethical or legal reasons or to avoid skewing the resulting scores of communication values. For example, if one sibling works for the first organization and a second sibling works for the second organization, communications between those two siblings may be disregarded for scoring the value of communications by individuals between the organizations to avoid an inaccurate assessment of the communications by including potentially personal or family related discussions. By way of further example, individuals associated with human resources or personnel decisions may be excluded from scoring and analysis in accordance with the present invention for legal or ethical reasons.

Systems and methods in accordance with the present invention may be utilized to provide benefit in a wide number of circumstances. One example of a benefit that may be provided in accordance with the present invention is the insurance of engagement of the appropriate individuals at a second organization through all desired levels of the organization. By way of further example, the present invention may permit an organization to identify the most valuable individuals within itself for relationships with a second organization. In this fashion, the appropriate individuals may be identified for promotion and advancement, providing additional training, or to better understand the nature of the relationship between the first organization and the second organization.

Different scoring algorithms may be used to provide an indication of the value provided to the relationship between organizations of a communication contact. For example, a communication of a particular type may be designated T. The value of T may be different for different types of communication contacts. All types of contact may have the same value of T, such as 1, but different types of communication contacts may have different values of T. For example, an email may have a T value of 1, while a VoIP call or a cell phone call may have a T value of 1.5, and a face-to-face meeting may have a T value of 2. A T value may also have a directional aspect. For example, an email sent by an associate with a first organization to an individual with a second organization may have a T value of 0.5 relative to the individual with the second organization, while an email sent by the individual with the second organization to the associate with the first organization may have a T value of 1. Types of communications may be determined based upon the communication media used, whether the communication is synchronous or asynchronous, etc. Further, a type of communication may have a further sub-type, sub-sub-type, or further gradations of classification, as desired.

A scoring algorithm may also score a communication contact based upon the role of one or more individuals involved with the communication. The contribution of the role of individuals involved with the communication may be denoted R. R may be a single value, such as 1, for all individuals, but the value for R may also vary for individuals with different roles in their organization. For example, in communicating with an organization that provides medical services, communication with doctors associated with the organization may be scored with an R value of 2, while communications with individuals having other roles may have different R values.

A scoring algorithm may also score a communication to place particularly high, or particularly low, value on communications with specific individuals beyond a value based upon the role of the individual. For example, some individuals may be particularly important to the success of a project that forms the basis of the relationship between organizations. The contribution of the identity of a particular individual to the value of a communication contact may be in addition to, instead of, or instead of the contribution to the value of the communication contact based upon the role of the individual. The contribution of the identity of an individual to the score of a communication contact may be designated I. I may be the same for all individuals, for example 1, but optionally may be greater than 1 for certain individuals of particular importance to a relationship. In some circumstances, I may be less than 1, or even 0 (if there is no value to communications with that individual, or to exclude those communications from scoring) or less than 0 (if communications with that individual are detrimental).

The number of individuals involved in a communication contact may be a factor in determining the value of that contact to the relationship. For example, the value of a communication contact may be inversely proportional to the number of individuals receiving the communication. The contribution to the score based upon the numerosity of individuals receiving or otherwise participating in a communication may be denoted N. If the value of a communication is inversely proportional to the number of recipients, N=1/(number of recipients). For example, an email sent to a single recipient would be scored using N=1/1=1, while an email sent to ten recipients would be scored using N= 1/10=0.1. Other relationships other than inverse proportionality may be used to adjust the score of a communication contact based upon the number of recipients or participants.

In one example of a score, these factors may be combined for a single communication contact to determine a score for that contact. For example, the score associated with a single contact may be denoted S and may be determined as:

S=T*R*I*N

Additional or fewer factors may be used in scoring a particular communication contact. For example, the time of a contact relative to a project schedule may be a component of a score algorithm. Also, the relationship of various factors need not be multiplicative, but may additionally/alternatively be additive, exponential, or otherwise related.

In calculating a score representative of the combined value of multiple communication contacts, a summation may be performed of a number of communication contacts. A single communication contact considered may be communication contact n. Scores may be determined and summed for all relevant communication contacts, from n=1 to n=final, with n=final denoting the last communication contact record to be scored. A summed score may be calculated for communications for a first organization with a second organization, communications for a first individual with a first organization and a second organization, communications for a first individual with first organization and a second individual with a second organization, communications for a first individual with first organization and a group of individuals (for example, all individuals with a particular role) with a second organization, etc. A time limit for consideration may be applied to the scoring, for example to limit scoring to contacts that occurred in the past 30, 60, 90, or 120 days. However the scope of the communication contacts to be scored is to be defined, the summed score, denoted Sₛ, may be determined by summing the score for all relevant communication contacts. For the example score algorithm presented above, the appropriate sum would be:

$${S}_{s} = {\sum }_{n = 1}^{n = final} {T}_{n} * {R}_{n} * {I}_{n} * {N}_{n}$$

Just as other types of scoring algorithms may be used within accordance with the present inventions to produce a score for a single communication contact that reflects the value of that contact to the relationship between organizations, other types of scoring algorithms may be used in summing the contributions of individual communication contacts. At least one of the factors may be greater than or less than 1 for at least some of the scores summed in calculating a summed score.

Scoring algorithms may be implemented using computer software stored in non-transitory media to cause a computing to device to perform a method to determine the score for a single or multiple communication contacts. Software implementing a scoring algorithm may reside at various locations within a system in accordance with the present invention, such as a contact valuation scorer as depicted in FIG. 1. However, a scoring algorithm may be implemented elsewhere in a system such as illustrated in FIG. 1 or in components beyond those illustrated in FIG. 1. A scoring algorithm may also be implemented by multiple components of a system, for example in a distributed computing environment. The components depicted in the example system of FIG. 1 and the steps depicted in the example methods of FIGS. 4 and 5 are for illustrative purposes only and are not limiting. Additional components and/or steps may be added, components and/or steps may be removed, and/or components and/or steps may be combined or consolidated in various ways without departing from the scope of the present invention.

Systems and methods in accordance with the present invention may also be used to manage contacts in the relationship of more than two organizations, or even within a single organization. The present invention is not limited to any particular industry, type of organization(s), or computer environment.

1. A method for managing relationship contacts between at least two distinct organizations, each of the distinct organizations comprising a plurality of individuals, the method comprising:
establishing at least a first database at a first organization, the at least a first database having entries identifying:
a first plurality of individuals associated with the first organization and a role for each of at least some of the first plurality of individuals in relationship to the first organization, and
a second plurality of individuals associated with the second organization and a role for each of at least some of the second plurality of individuals in relationship to the second organization;
maintaining digital records of at least some communication contacts between the at least some of the first plurality of individuals and at least some of the second plurality of individuals, the digital records identifying:
the communication contact type, such that at least some communications are identified as asynchronous and at least some other communications are identified as synchronous,
the identities of at least a portion of the participants to the communication,
the roles of individuals participating in the communication, and
the nature of the involvement of at least a portion of the participants in the communication;
periodically analyzing the digital records of communication contacts between individuals associated with the first organization identified in the at least a first database and individuals associated with at least a second organization;
based upon the periodic analysis of digital records of communication contacts between individuals associated with the first organization and individuals associated with the second organization, creating new entries in the at least a first database identifying individuals associated with the second organization and the role of at least some of the individuals associated with the second organization when the digital communication contact records provide data regarding individuals associated with the second organization not contained in the at least a first database;
based upon the periodic analysis of digital records of communication contacts between individuals associated with the first organization and individuals associated with the second organization, generating at least one overall score of the relationship quality evidenced between the first organization and the second organization by the communication contacts, scoring the relationship quality comprising assigning a value to at least some of the communication contact records based upon:
the communication contact type, such that real-time communications receive a different valuation than asynchronous communications,
the number of participants to the communication, such that the valuation of a communication is inversely proportional to the number of participants to the communication,
the roles of participants to the communication, such that at least some communications with participants having different roles with the second organization receive a different valuation than communications with participants having other roles with the second organization, and
the nature of involvement of the identified participants to the communication, such that a communication is valued differently when a participant having a particular role with the second organization participates in a communication in a particular nature;
based upon the periodic analysis of digital records of communication contacts between individuals associated with the first organization and individuals associated with the second organization, generating at least one sub-score for communications with individuals having at least one of the predefined roles, the generation of the at least one sub-score based upon only digital records of communication contacts with participants having at least one predetermined role; and
issuing an alert if the at least one sub-score falls outside of a predetermined range, the predetermined range selected to represent an expected healthy relationship between the first organization and the second organization.

2. The method of claim 1, wherein synchronous communications comprise at least telephone calls and in-person meetings, and wherein asynchronous communications comprise at least electronic mail.

3. The method of claim 1, wherein the roles identified in digital records comprise a first plurality of roles for individuals associated with the first organization and a second plurality of roles associated with the second organization.

4. The method of claim 3, wherein generating at least one sub-score for communications with individuals having at least one of the predefined roles further comprises generating a sub-score for communications initiated by individuals with the second organization with individuals having a support role with the first organization.

5. The method of claim 4, wherein issuing an alert if the at least one sub-score falls outside of a predetermined range comprises issuing an alert if the at least one sub-score indicates an elevated level of technical support by the first organization.

6. The method of claim 3, wherein generating at least one sub-score for communications with individuals having at least one of the predefined roles further comprises generating a sub-score for communications initiated by individuals with the first organization with individuals having a role with the second organization previously defined as critical.

7. The method of claim 6, wherein the second organization comprises an organization delivering medical services to patients, and wherein the role with the second organization previously defined as critical comprises a doctor role.

8. The method of claim 6, wherein issuing an alert if the at least one sub-score falls outside of a predetermined range comprises issuing an alert if the at least one sub-score indicates an inadequate level of contact by the first organization with individuals having a role with the second organization previously defined as critical.

9. The method of claim 1, wherein generating at least one overall score comprises assigning a value to each communication contact record and summing the score of at least a portion of the communication contact records, assigning a value to each communication contact record further comprises decreasing the value assigned to a communication contact record based upon the date of the communication, such that older communications receive a lower value than newer communications.

10. A method for managing relationship contacts between at least two distinct organizations, each of the distinct organizations comprising a plurality of individuals, the method comprising:
establishing at least a first database at a first organization, the at least a first database having entries identifying, for the first organization, a plurality of individuals associated with the first organization and the role of those individuals at the first organization, role of each of those individuals being one of a predefined set of roles;
maintaining digital records of at least some communication contacts between the plurality of individuals associated with the first organization and individuals associated with at least a second organization, the records identifying the communication type, the identities of at least a portion of the participants to the communication, and the nature of the involvement in the communication of the participants;
periodically analyzing digital records of communication contacts between individuals associated with the first organization identified in the at least a first database and individuals associated with at least a second organization;
based upon the analysis of the digital records of communication contacts, scoring contacts involving individuals associated with the first organization with at least a first role to generate a score describing the nature of the relationship between the first organization and the second organization; and
issuing a notification if the score generated falls outside of a predefined range indicative of a healthy relationship between the first organization and the second organization.

11. The method of claim 10, wherein the predefined set of roles for individuals at the first organization comprise at least a sales role and at least a support role.

12. The method of claim 11, wherein scoring contacts involving individuals associated with the first organization with at least a first role to generate a score describing the nature of the relationship between the first organization and the second organization comprises scoring contacts involving individuals associated with a support role at the first organization, and wherein issuing a notification if the score generated falls outside of a predefined range indicative of a healthy relationship between the first organization and the second organization comprises issuing a notification if a score generated indicates an increased level of support needs by the second organization.

13. The method of claim 10, wherein scoring contacts involving individuals associated with the first organization with at least a first role to generate a score describing the nature of the relationship between the first organization and the second organization comprises assigning a value to each digital record of a communication contact, the value assigned being inversely proportional to the number of participants to the communication and decreasing in relation to the age of the communication, such that older communication receive a lower valuation than newer communications.

14. Non-transitory computer storage media containing computer-executable instructions that, when executed perform a method for managing the contacts between organizations of multiple individuals, the method comprising the steps of:
establishing at least one database, the at least one database comprising entries for a plurality of individuals, the database having for each individual:
a unique identifier for that individual,
an organization with which that individual is associated, and
descriptions of the communications between that individual and at least a second individual having an entry in the database, the second individual being associated with a second organization;
collecting information describing communications between individuals having entries within the at least one database, the information comprising at least the date of the communication, information sufficient to identify the individual initiating the communication, information sufficient to identify at least one individual receiving the initiation of the communication, and information sufficient to describe the type of communication initiated;
updating the at least one database with the collected information;
scoring the value of at least some of the communications identified within the at least one database as associated with a first organization and at least a second individual identified within the at least one database as associated with a second organization, scoring the value of communications comprising assigning a value to each of at least some of the communications identified within the database as involving a subset of individuals, the value assigned based upon whether the communication was initiated by an individual with the first organization or the second organization and the type of communication; and
generating an output based upon the score value, the score value indicative of the relationship between the first organization and the second organization.

15. The non-transitory computer storage media containing computer-executable instructions of claim 14, wherein the subset of individuals for whom communications are scored comprises individuals associated with a predefined role with the first organization.

16. The non-transitory computer storage media containing computer-executable instructions of claim 15, wherein the predefined role comprises a technological support role, and wherein the score value indicates the amount of technological support the second organization has requested from the first organization.

17. The non-transitory computer storage media containing computer-executable instructions of claim 16, wherein the method further comprises issuing a notification to the first organization if the score value indicates that the amount of technological support requested by the second organization may indicate a technological problem to be addressed by the first organization.

18. The non-transitory computer storage media containing computer-executable instructions of claim 14, wherein the subset of individuals for whom communications are scored comprises individuals associated with a predefined role with the second organization.

19. The non-transitory computer storage media containing computer-executable instructions of claim 14, wherein the value assigned to a communication further depends upon:
the number of participants to the communication, with the value of the communication being inversely proportional to the number of participants;
the type of the communication, with synchronous communications being valued differently than asynchronous communications; and
the timing of the communication, with older communications valued less than newer communications.

20. The non-transitory computer storage media containing computer-executable instructions of claim 19, wherein the value assigned to a communication further depends upon the role of individuals associated with the second organization participating in the communication and the role of individuals associated with the first organization participating in the communication.
